(19) United States
(12) Patent Application Publication
(10) Pub. No.: US 2024/0021332 A1
(43) Pub. Date: Jan. 18, 2024

(54) OVERMOLDED FUEL PELLETS AND METHODS OF MANUFACTURE THEREOF

(71) Applicant: JFoster & Associates, LLC, Idaho Falls, ID (US)

(72) Inventors: Patrick John MOO, Shelley, ID (US); Allen Andrew BEASLEY, Okemah, OK (US); John Darrell BESS, Idaho Falls, ID (US)

(21) Appl. No.: 17/865,056

(22) Filed: Jul. 14, 2022

(51) Int. Cl. G21C 21/12; B22F 3/22; B22F 3/10

(52) U.S. Cl. CPC G21C 21/12; B22F 3/225; B22F 3/1021

(57) ABSTRACT

A method of manufacturing a fuel pellet includes obtaining a first material containing a nuclear fuel in a first region with a longitudinal axis and overmolding a second material in a second region around at least a radially outermost surface of the first material relative to the longitudinal axis.

### BACKGROUND

### Background and Relevant Art

Most nuclear fuel materials include one or more of the elements of uranium and plutonium. There are, however, different types or forms of nuclear fuel materials that include such elements. For example, nuclear fuel pellets (NFPs) may be used to accommodate a variety of reactor sizes and types.

The nuclear reaction including the NFPs involves the disintegration of the nuclear fuel material into two or more fission products of lower mass number. The reaction process produces a net increase in the available free neutrons, which form the basis for a self-sustaining nuclear reaction. To control the rate of the nuclear reaction, neutron-capturing elements may be added to the nuclear fuel material to compensate for initial higher reactivity of the nuclear fuel material. Neutron-capturing elements can include a neutron capturing material (e.g., burnable absorber or burnable neutron capturing material) that has a high probability of absorbing neutrons while producing no new or additional neutrons or changing into new neutron capturing materials as a result of neutron absorption.

During a nuclear reaction, heat is generated within the NFP and, more particularly, a thermal gradient is generated within the NFP such that the greatest heat is generated in a central region (e.g., lateral and/or longitudinal center) of the NFP. However, neutron capturing materials can have a lower melting point relative to nuclear fuel materials within the NFP, which can result in the NFP softening and changing geometries as the heat increases. The combination of the NFP softening and generation of the thermal gradient contributes to deformation of the NFP. Deformation of the NFP is described as taking on an hourglass shape. The combination of hourglass shape and pellet cracking create shearing pinch points (triple points) onto the inner diameter of the fuel cladding. These pellet-cladding-mechanical-interactions (PCMI) can lead to rupture of the cladding material which serves as a barrier between the NFPs and the reactor coolant.

### BRIEF SUMMARY

In some embodiments, a method of manufacturing a fuel pellet includes obtaining a first material containing a nuclear fuel in a first region with a longitudinal axis and overmolding a second material in a second region around at least a radially outermost surface of the first material relative to the longitudinal axis.

In some embodiments, a nuclear fuel pellet includes a first material containing a first nuclear fuel positioned in a first region proximate a longitudinal axis of the nuclear fuel pellet and a second material positioned in a second region around at least a radially outermost surface of the first material relative to the longitudinal axis, wherein a boundary layer between the first material and second material is less than 500 micrometers.

In some embodiments, a method of manufacturing a fuel pellet includes injection molding a first material containing a nuclear fuel in a first region with a longitudinal axis and overmolding a second material via injection molding in a second region around at least a radially outermost surface of the first material relative to the longitudinal axis. The method further includes debinding at least one of the first material and the second material, sintering at least one of the first material and the second material, and densifying at least one of the first material and the second material.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a side cross-sectional view of a nuclear fuel pellet (NFP), according to at least some embodiments of the present disclosure;

FIG. 2 is a side cross-sectional view of another NFP, according to at least some embodiments of the present disclosure;

FIG. 3 is a side cross-sectional view of an NFP with concave axial surfaces, according to at least some embodiments of the present disclosure;

FIG. 4 is a side cross-sectional view of a composition gradient of an NFP, according to at least some embodiments of the present disclosure;

FIG. 5 is a flowchart illustrating a method of manufacturing an NFP, according to at least some embodiments of the present disclosure;

FIG. 6 is a side cross-sectional schematic of a powder injection molding device, according to at least some embodiments of the present disclosure;

FIG. 7 is a side cross-sectional view of an NFP with a mandrel therethrough, according to at least some embodiments of the present disclosure;

FIG. 8 is a side cross-sectional view of an NFP with regions having different geometries, according to at least some embodiments of the present disclosure; and

FIG. 9 is a flowchart illustrating a method of overmolding an NFP, according to at least some embodiments of the present disclosure.

### DETAILED DESCRIPTION

The present disclosure generally relates to nuclear fuel pellets and to the systems and methods for manufacturing nuclear fuel pellets. More particularly, the present disclosure relates to heterogeneous nuclear fuel pellets and to the systems and methods for manufacturing heterogeneous nuclear fuel pellets. In some embodiments, a nuclear fuel pellet (NFP) according to the present disclosure includes a first region containing a first material including a nuclear fuel and a second region positioned around at least a portion of the first region, where the second region contains a second material different from the first material. In some embodiments, the second material includes the nuclear fuel in a different proportion. In some embodiments, the second material includes a different nuclear fuel. In some embodiments, the second material lacks a nuclear fuel.

An NFP may be manufactured by overmolding the second material around at least a portion of the first material. Conventional NFPs are a homogeneous composition including a nuclear fuel, a binder, breeding material, burnable neutron capturing materials, or combinations thereof. Due to the uneven distribution of fission, heat, and exhaustion of byproducts, a conventional homogenous NFP can burn incompletely or inefficiently. In some examples, a conventional NFP can distort in shape during the fission process, causing further challenges with boundary effects and control of the fission in the NFP.

In some embodiments, a heterogeneous NFP can change ratios or types of nuclear fuel or other components in the various regions of the NFP to mitigate and/or leverage the different fission rates, temperatures, and/or byproducts in the NFP while remaining compatible with existing reactors such as light-water reactors (LWRs). In contrast to conventional press power and sintering methods, the systems and methods for manufacturing NFPs described herein provide improved precision and control over the placement and distribution of different components of the NFP.

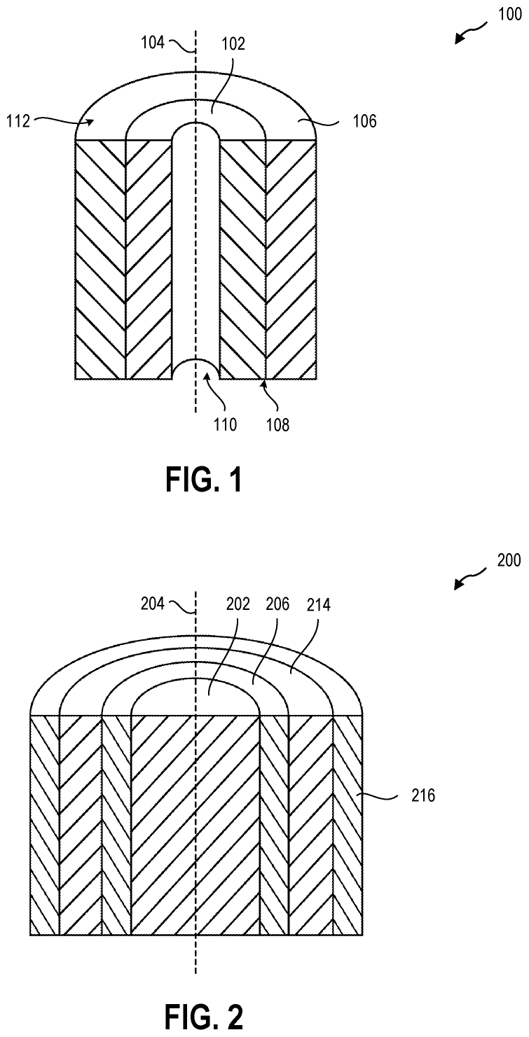

FIG. 1 is a side cross-sectional view of an NFP 100, according to some embodiments of the present disclosure. The NFP 100 is generally cylindrical with a first region 102 of a first material positioned proximate a longitudinal axis 104 of the NFP 100. A second region 106 is positioned circumferentially around the first region 102 on a radially outermost surface 108 of the first region 102. In some embodiments, the second region 106 also contacts at least a portion of the axial surface 112 of the first region 102. In some embodiments, the second region 106 is positioned around the first region 102 only in the radial direction (relative to the longitudinal axis 104). In some embodiments, the NFP 100 has a longitudinal channel or hole 110 through at least a portion thereof in the longitudinal direction. In some embodiments, the hole 110 allows exhaust of heat and/or byproducts (such as gases) during the reaction process to control the deformation of the NFP 100. In some embodiments, the hole 110 allows for capture and/or removal of heat from a region of the NFP 100 near the first material. The axial centerline is the hottest region of an NFP. Removal of the centerline (an annular NFP) lowers thermal gradient and related stresses.

In some embodiments, the NFP 100 has an axial surface 112 that is substantially planar. For example, the illustrated embodiment in FIG. 1 has an axial surface 112 that is planar and perpendicular to the longitudinal axis 104. In other embodiments, at least a portion of the axial surface is curved, such as concave (a dish) or convex, or has corners, such as chamfered edges, grooves, or rings as will described in greater detail herein.

FIG. 2 is a cross-sectional view of another embodiment of an NFP 200 with a solid first region 202 (e.g., lacking a hole 110 described in relation to FIG. 1) and a plurality of additional regions of different materials positioned radially outside of the first region 202. In some embodiments, the first region 202 includes a nuclear fuel, and a second region 206 positioned radially outside of the first region 202 relative to the longitudinal axis 204 includes a second material that is different from the first material. The third region 214, which is positioned radially outside of the second region 206, includes a third material that is different from the second material. In some embodiments, the third material is the same as the first material, as well. In other embodiments, the third material is different from both the first material and the second material. The fourth region 216, which is positioned radially outside of the third region 214, includes a fourth material that is different from the third material. In some embodiments, the fourth material is the same as the first material or the second material, as well. In other embodiments, the fourth material is different from both the first material and the second material, as well.

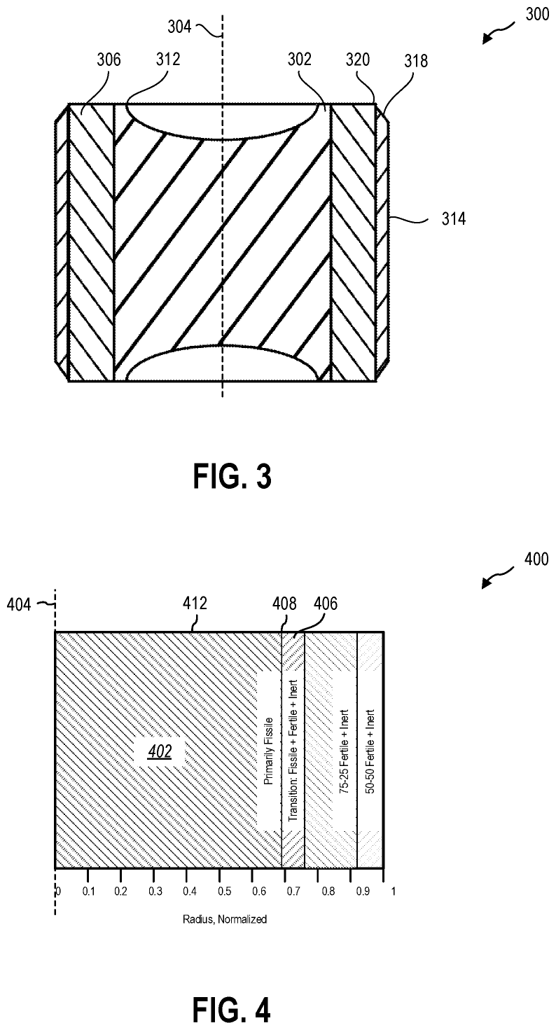

FIG. 3 is a side cross-sectional view of another example of an NFP 300 according to the present disclosure. As described herein, an axial surface 312 of the NFP 300 may be non-planar in one or more directions. For example, an NFP 300 may have one or more depressed axial surfaces 312 to accommodate thermal expansion of the material closest the longitudinal axis (as the concentration of heat, and therefore thermal expansion, is greatest near the center of the NFP 300). In at least one example, an axial surface 312 of the first region 302 has a concave profile in transverse cross-section to accommodate thermal expansion of the first material. In some embodiments, the second material of the second region 306 may have a lower coefficient of thermal expansion (CTE) and/or absorb less heat during the fission reaction.

In some embodiments, an axial surface 312 of the NFP 300 and/or regions thereof may have different geometries or surface features thereon. For example, the second region 306 of the NFP 300 of FIG. 3 has an axial surface 312 that is substantially planar and annular around the longitudinal axis 304, while the third region 314 has a beveled edge 318 that is sloped with a corner 320 or other discontinuity between the second region 306 and the third region 314. In other embodiments, the third region 314 has a chamfered edge 318 that meets the second region 306 at a continuous curve. While FIG. 3 illustrates the concave portion of the axial surface 312 localized within the first region 302, in some embodiments, a concave or convex portion of the axial surface 312 is continuous across a plurality of regions and/or materials of the NFP 300.

As will be described herein, overmolding and, in particular, injection molding allows for each region to be built upon a radially inward region with unique geometry for each region and/or material. In other embodiments, overmolding and, in particular, injection molding allows for each region to be built upon a radially outward layer, allowing an annular region to be at least partially filled by injection of material into a radially inward space. In some embodiments, the radial series of materials can allow for a precise control of sustained fission through layering of nuclear fuel material, neutron capturing material, breeding material, inert material, etc.

FIG. 4 is a radial cross-sectional view of a NFP 400 with varying material composition in each region. In some embodiments, the NFP 400 has a configuration for extended burnup and rim effect suppression. A primarily fissile first region 402 may include 10% enriched LEU or similar and transition second region 406 may include ²³⁸U or ²³²Th species (“Fertile”). An ‘inert’ material or component of a material may be ZrO₂ or other non-breeding material. Other additions may include moderators such as BeO or burnable neutron capturing materials such as Gd₂O₃. It should be understood that the compositions described in relation to FIG. 4 are exemplary and not limiting.

Generally, the NFP 400 may include (e.g., be comprised of) any appropriate nuclear fuel material. In some embodiments, the nuclear fuel material may comprise one or more of uranium, zirconium, tungsten, rhenium, molybdenum, tantalum, iridium, uranium dioxide (UO₂), uranium oxide (e.g., U₃O₈), uranium nitride (e.g., UN, U₂N₃, etc.), uranium silicide (e.g., U₃Si₂), uranium borides (e.g., UB₂, UB₄), a transuranic material (e.g., plutonium, plutonium oxide), minor actinides (e.g. neptunium, americium, curium), thorium, oxides thereof, another nuclear fuel material, or combinations thereof. The NFP 400 may also include (e.g., be comprised of) any appropriate additive, or dopant, material. In some embodiments, the additive material may be a neutron capturing material, such as a burnable neutron capturing material. In some embodiments, the neutron capturing material may comprise one or more of boron, gadolinium, gadolinium oxide (Gd₂O₃), boron carbide (B4C), another material exhibiting a high thermal neutron absorption cross-section, and combinations thereof. Other neutron capturing materials may include, molybdenum, neodymium, cadmium, erbium, hafnium, another neutron absorber, or combinations thereof.

In some embodiments, the neutron capturing material may be disposed in a region of the NFP 400 in which it will have the greatest impact on the nuclear reaction within a nuclear reactor (e.g., to enhance neutronic efficiency of the nuclear fuel material and the neutron capturing material therein) and may be excluded from other regions of the NFP 400. In some embodiments, the neutron capturing material may be excluded from a first region (e.g., a lateral and/or longitudinal center located proximate to the longitudinal axis 404) of the NFP 400 so as to inhibit deformation (e.g., hour-glassing) of the NFP 400. In other embodiments, the neutron capturing material may also be excluded from or reduced in a gradient toward the axial surfaces 412 of the NFP 400.

For example, the NFP 400 may be heterogeneous in composition across a height thereof (e.g., axially, in the longitudinal direction) and/or across a width thereof (e.g., radially from the longitudinal axis), such that amounts (e.g., concentrations) of one or more elements thereof are non-uniform within the NFP 400 and/or within one or more regions of the NFP 400. The heterogeneity of the NFP 400 and/or regions of the NFP may be substantially undetectable by visual inspection (e.g., no clear delineation of first region 402 and second regions 406), but the heterogeneity of the NFP 400 and/or regions of the NFP may be detectable by conventional spectroscopy or spectrometry techniques. A boundary between regions of different compositions within the fuel pellets may generally have a roughness at least partially defined by the microstructure of the NFP 400. Fine-grained and uniformed materials may exhibit a smoother or more uniform boundary, and coarse-grained materials may exhibit a rougher boundary. Some irregularity of the boundary may also be attributable to different particle sizes in various regions of the NFP 400.

A boundary layer is a region in which components of both neighboring regions mix and a boundary material is formed through the migration of materials. In some embodiments, a boundary layer between regions formed by overmolding and/or injection molding is smaller (e.g., thinner in a direction normal to the boundary surface 408 between regions) than powder sintering of two powder precursors adjacent to one another. The more precise control enabled by the overmolding and/or injection molding according to the present disclosure allows, in some embodiments, a boundary layer thickness of less than 500 micrometers, less than 300 micrometers, less than 200 micrometers, or less than 100 micrometers. The exact thickness of the boundary layer is at least partially dependent on the materials in each of the neighboring regions.

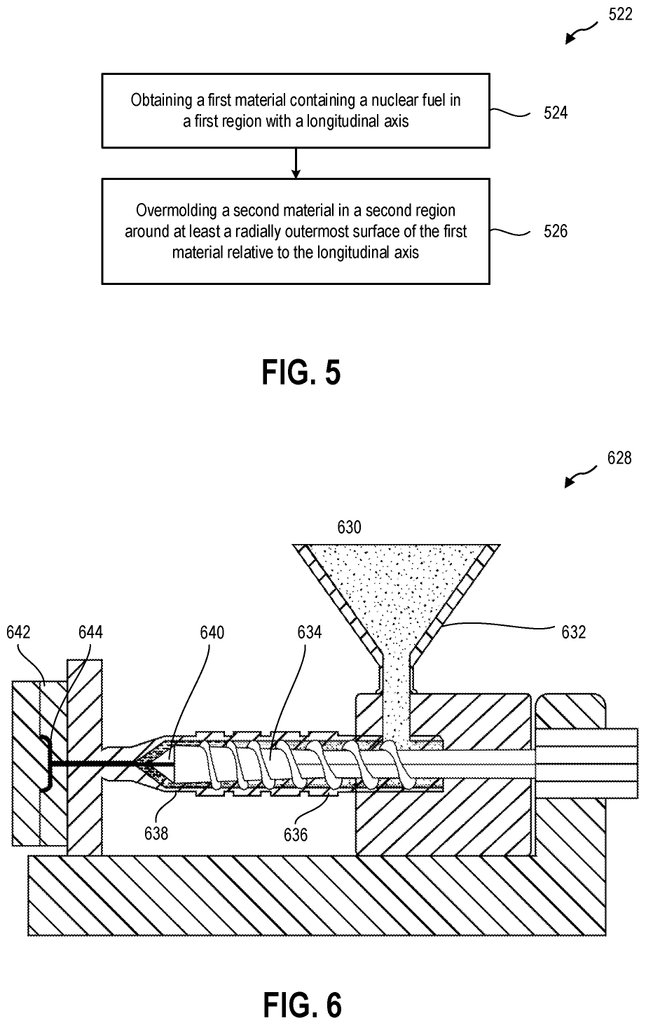

FIG. 5 is a flowchart illustrating a method 522 for overmolding an NFP, according to some embodiments of the present disclosure. In some embodiments, the method 522 includes obtaining a first material containing a nuclear fuel in a first region with a longitudinal axis at 524 and overmolding a second material in a second region around at least a radially outermost surface of the first material relative to the longitudinal axis at 526. Obtaining a first material containing a nuclear fuel in a first region may include a variety of manufacturing techniques.

In some embodiments, the first region is formed through powder sintering of a precursor powder of the first material. The first material may be sintered or debinded to a densified or brown state in the first region before overmolding the second material in the second region. In other embodiments, the first region is formed by injection molding of a first material feedstock through a powder injection molding device into a first mold. The first material is compressed through the injection molding device into the first mold, where the first material assumes the shape of a void of the first mold in a green state. In yet other embodiments, the first material may be pressed without sintering or debinding to form the first region.

Overmolding the second material in the second region at 526 includes positioning the first material in a powder injection molding device in a mold with a void at least around a radially outermost surface of the first material. The second material is compressed through the injection molding device and urged into the void around the first material to assume the shape of the mold. In an embodiment where the first region is injection molded, the second material is injection molded using a second mold with a mold volume greater than the first mold used for the first region.

In some embodiments, the overmolding at 526 is performed with a powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets or the feedstock may contain a mixture of ceramic-matrix pellets and metal-matrix pellets that blend in the PIM device. Overmolding, as used herein, includes applying a second material to a surface of a first material when the first material is in a first region in a near-final state. Once the part is cooled and solidified, it may be removed from the mold. The entire injection forming process occurs on the order of seconds. Molds can be configured to produce dozens of LWR fuel pellet-sized parts at a time for efficient and rapid production of NFPs. In some embodiments, the overmolding process is repeated with another material that is applied to at least a radially outermost surface of a previous region.

In some embodiments, the feedstock for one or more of the materials injection molded into the NFP includes a binder. For example, the feedstock may include a binder that melts or softens during the PIM process to allow the feedstock pellets to flow through the PIM device more easily and for the material being injected into the mold to more easily assume the form of the void in the mold. In some embodiments, the binder is a wax binder, such as paraffin. In some embodiments, the binder is a polymer binder, such as polyethylene. In some embodiments, the feedstock includes both a wax binder and a polymer binder.

Because the first material, second material, or additional materials (such as the third material, fourth material, etc. described in some embodiments herein) may include binders, the NFP formed by overmolding may, optionally, require debinding. Debinding removes the wax and/or polymer binder matrix, leaving only the original raw material (such as UO₂) and may be performed through one or a combination of solvent, catalytic, or thermally driven processes. In some embodiments, the method 522 further includes debinding the overmolded NFP by exposing the NFP to an elevated temperature greater than a temperature of the first material and/or second material during PIM. In some embodiments, debinding the overmolded NFP includes debinding at a second elevated temperature after debinding at the first elevated temperature. In at least one embodiment, debinding the overmolded NFP includes exposing the NFP to a solvent while heated to the first elevated temperature and/or second elevated temperature. For example, the NFP may be heated to a first elevated temperature while exposed to heptane, acetone, or another organic solvent. In another example, the NFP may be heated to a second elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering. In some embodiments, the ambient atmosphere around the NFP in the furnace can be changed to necessary atmosphere for sintering, which may include H₂ and vacuum capability to limit oxidation or other chemical changes during the sintering of the debinded NFP. In some embodiments, sintering the NFP also densifies the NFP, allowing the first material, second material, or other materials of the NFP to attain 98%, 99%, or approximately 100% of theoretical maximum density.

FIG. 6 is a schematic illustration of an embodiment of a PIM device 628. In some embodiments, a feedstock 630 is loaded into a feed hopper 632 of the PIM device 628. The feedstock 630 may include a material pre-mixed with binders or may include a powder of the desired material with additional binders added to the powder. A screw or screws 634 of the PIM device 628 rotates to compound the feedstock 630 through a barrel 638. In some embodiments, a heating element 636 heats the barrel 638 and/or screw(s) 634 to soften and/or melt at least a portion of the feedstock 630. The feedstock 630 flows past the plunger 640 into the mold 642 to form the molded part 644 or a portion of the molded part 644.

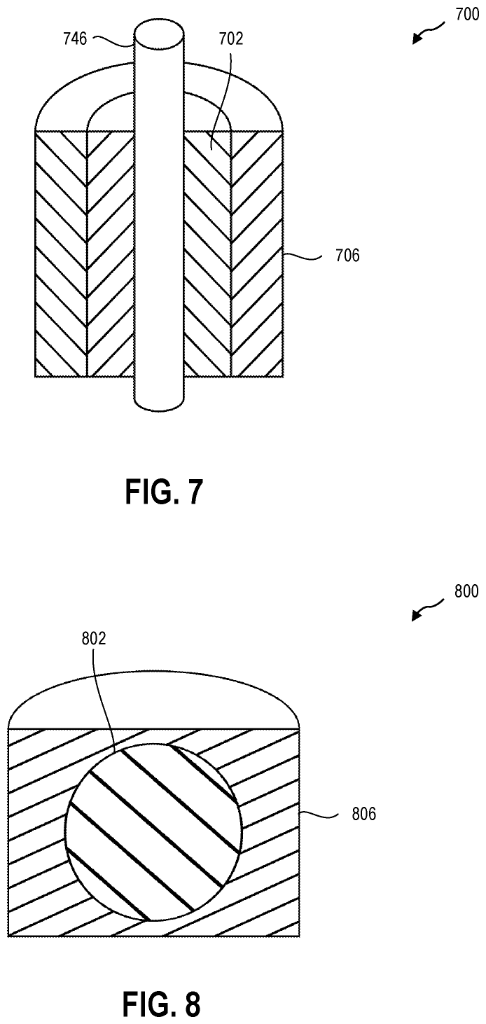

As described herein, an NFP may have a cylindrical shape, but also may have other shapes depending on the need of the reactor. For example, an NFP according to the present disclosure may be formed by PIM around a mandrel, as shown in FIG. 7. In some embodiments, the mandrel 746 can support the NFP 700 and regions thereof during the serial PIM of the first region 702, the second region 706, or more regions of different materials. In some embodiments, the mandrel 746 can be subsequently removed by heating, melting, or dissolving the mandrel 746. In other examples, a support structure or scaffolding may be used with the PIM to provide a support structure during the PIM, which is later removed. In some embodiments, the void that remains in the NFP 700 after removal of the mandrel 746 and/or other support structure may aid in heat transfer or byproduct transfer through or out of the NFP 700.

In some embodiments, an NFP has a non-cylindrical shape. PIM allows for the NFP to have any shape produced by an injection molding process, such as slabs, parallelepipeds, spheres, polygons, etc. The individual layers or regions themselves may take on a variety of shapes or have irregular thicknesses (such as a corrugation, fluting, etc.). For example, FIG. 8 illustrates an embodiment of a cylindrical NFP 800 with a non-cylindrical first region 802. The first region of FIG. 8 is substantially spherical with a second region 806 that has a substantially cylindrical outer surface.

Because PIM and other injection molding techniques discussed herein for overmolding provide a high grade of surface finish and surface quality, the NFP is removed from the mold in a near-final form. In some embodiments, an NFP in near-final form requires little or no final machining to provide an NFP in final form. In some examples, the NFP, upon removal form the mold, may require sintering and/or debinding but little or no final machining.

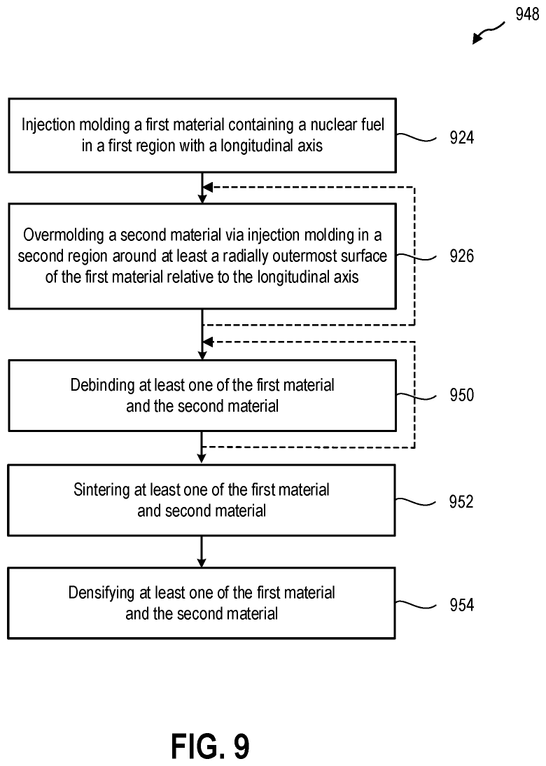

FIG. 9 is a flowchart illustrating an embodiment of a method of manufacturing an NFP according to the present disclosure. In some embodiments, the method 948 includes injection molding of a first material feedstock containing a nuclear fuel through a powder injection molding device into a first mold at 924. The first material is compressed through the injection molding device into the first mold, where the first material assumes the shape of a void of the first mold in a green state. In yet other embodiments, the first material may be pressed without sintering to form the first region.

Overmolding the second material in the second region at 926 includes positioning the first material in a powder injection molding device in a mold with a void at least around a radially outermost surface of the first material. The second material is compressed through the injection molding device and urged into the void around the first material to assume the shape of the mold. In an embodiment where the first region is injection molded, the second material is injection molded using a second mold with a mold volume greater than the first mold used for the first region.

In some embodiments, the overmolding at 926 is performed with a powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets, or the feedstock may contain a mixture of ceramic-matrix pellets and metal-matrix pellets that blend in the PIM device. Overmolding, as used herein, includes applying a second material to a surface of a first material when the first material is in a first region in a near-final state. Once the part is cooled and solidified, it may be removed from the mold. The entire injection forming process occurs on the order of seconds. Molds can be configured to produce dozens of LWR fuel pellet-sized parts at a time for efficient and rapid production of NFPs. In some embodiments, the overmolding process at 926 is repeated with another material that is applied to at least a radially outermost surface of a previous region.

In some embodiments, the feedstock for one or more of the materials injection molded into the NFP includes a binder. For example, the feedstock may include a binder that melts or softens during the PIM process to allow the feedstock pellets to flow through the PIM device more easily and for the material being injected into the mold to more easily assume the form of the void in the mold. In some embodiments, the binder is a wax binder, such as paraffin. In some embodiments, the binder is a polymer binder, such as polyethylene. In some embodiments, the feedstock includes both a wax binder and a polymer binder.

Because the first material, second material, or additional materials (such as the third material, fourth material, etc. described in some embodiments herein) may include binders, the NFP formed by overmolding may, optionally, require debinding at 950. Debinding removes the wax and/or polymer binder matrix, leaving only the original raw material (such as UO₂) and may be performed through one or a combination of solvent, catalytic, or thermally driven processes. In some embodiments, the method 948 further includes debinding the overmolded NFP by exposing the NFP to an elevated temperature greater than a temperature of the first material and/or second material during PIM. In some embodiments, debinding the overmolded NFP includes debinding at a second elevated temperature after debinding at the first elevated temperature at 950. In at least one embodiment, debinding the overmolded NFP includes exposing the NFP to a solvent while heated to the first elevated temperature and/or second elevated temperature. For example, the NFP may be heated to a first elevated temperature while exposed to heptane, acetone, or another organic solvent. In another example, the NFP may be heated to a second elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering of at least one of the first material and the second material at 954. In some embodiments, the ambient atmosphere around the NFP in the furnace can be changed to necessary atmosphere for sintering, which may include H₂ and vacuum capability to limit oxidation or other chemical changes during the sintering of the debinded NFP. In some embodiments, sintering the NFP also densifies at least one of the first material and the second material of the NFP at 954, allowing the first material, second material, or other materials of the NFP to attain 98%, 99%, or approximately 100% of theoretical maximum density. In other embodiments, densifying at least one of the first material and the second material at 954 is discrete from the sintering. For example, the sintering at 952 and the densifying at 954 may occur at different temperatures or atmospheric conditions.

### INDUSTRIAL APPLICABILITY

The present disclosure generally relates to nuclear fuel pellets and to the systems and methods for manufacturing nuclear fuel pellets. More particularly, the present disclosure relates to heterogeneous nuclear fuel pellets and the to the systems and methods for manufacturing heterogeneous nuclear fuel pellets. In some embodiments, a nuclear fuel pellet (NFP) according to the present disclosure includes a first region containing a first material including a nuclear fuel and a second region positioned around at least a portion of the first region, where the second region contains a second material different from the first material. In some embodiments, the second material includes the nuclear fuel in a different proportion. In some embodiments, the second material includes a different nuclear fuel. In some embodiments, the second material lacks a nuclear fuel.

An NFP may be manufactured by overmolding the second material around at least a portion of the first material. Conventional NFPs are a homogeneous composition including a nuclear fuel, a binder, breeding material, burnable neutron capturing materials, or combinations thereof. Due to the uneven distribution of fission, heat, and exhaustion of byproducts, a conventional homogenous NFP can burn incompletely or inefficiently. In some examples, a conventional NFP can distort in shape during the fission process, causing further challenges with boundary effects and control of the fission in the NFP.

In some embodiments, a heterogeneous NFP can change ratios or types of nuclear fuel or other components in the various regions of the NFP to mitigate and/or leverage the different fission rates, temperatures, and/or byproducts in the NFP while remaining compatible with existing reactors such as light-water reactors (LWRs). In contrast to conventional press power and sintering methods, the systems and methods for manufacturing NFPs described herein provide improved precision and control over the placement and distribution of different components of the NFP.

According to some embodiments of the present disclosure, an NFP is generally cylindrical with a first region of a first material positioned proximate a longitudinal axis of the NFP. A second region is positioned circumferentially around the first region on a radially outermost surface of the first region. In some embodiments, the second region also contacts at least a portion of the axial surface of the first region. In some embodiments, the second region is positioned around the first region only in the radial direction (relative to the longitudinal axis). In some embodiments, the NFP has a longitudinal channel or hole through at least a portion thereof in the longitudinal direction. In some embodiments, the hole allows exhaust of heat and/or byproducts (such as gases) during the reaction process to control the deformation of the NFP. In some embodiments, the hole allows for capture and/or removal of heat from a region of the NFP near the first material. The axial centerline is the hottest region of an NFP. Removal of the centerline (an annular NFP) lowers thermal gradient and related stresses.

In some embodiments, the NFP has an axial surface that is substantially planar. For example, an NFP may have an axial surface that is planar and perpendicular to the longitudinal axis. In other embodiments, at least a portion of the axial surface is curved, such as concave (a dish) or convex, or has corners, such as chamfered edges, grooves, or rings as will described in greater detail herein.

In some embodiments, the first region includes a nuclear fuel, and a second region positioned radially outside of the first region relative to the longitudinal axis includes a second material that is different from the first material. A third region, which is positioned radially outside of the second region, includes a third material that is different from the second material. In some embodiments, the third material is the same as the first material, as well. In other embodiments, the third material is different from both the first material and the second material. A fourth region, which is positioned radially outside of the third region, includes a fourth material that is different from the third material. In some embodiments, the fourth material is the same as the first material or the second material, as well. In other embodiments, the fourth material is different from both the first material and the second material, as well.

As described herein, an axial surface of the NFP may be non-planar in one or more directions. For example, an NFP may have one or more depressed axial surfaces to accommodate thermal expansion of the material closest the longitudinal axis (as the concentration of heat, and therefore thermal expansion, is greatest near the center of the NFP). In at least one example, an axial surface of the first region has a concave profile in transverse cross-section to accommodate thermal expansion of the first material. In some embodiments, the second material of the second region may have a lower coefficient of thermal expansion (CTE) and/or absorb less heat during the fission reaction.

In some embodiments, an axial surface of the NFP and/or regions thereof may have different geometries or surface features thereon. For example, the second region of the NFP has an axial surface that is substantially planar and annular around the longitudinal axis, while the third region has a chamfered edge that is sloped with a corner or other discontinuity between the second region and the third region. In other embodiments, the third region has a beveled edge that meets the second region at a continuous curve. In some embodiments, a concave or convex portion of the axial surface is continuous across a plurality of regions and/or materials of the NFP.

As will be described herein, overmolding and, in particular, injection molding allows for each region to be built upon a radially inward region with unique geometry for each region and/or material. In other embodiments, overmolding and, in particular, injection molding allows for each region to be built upon a radially outward layer, allowing an annular region to be at least partially filled by injection of material into a radially inward space. In some embodiments, the radial series of materials can allow for a precise control of sustained fission through layering of nuclear fuel material, neutron capturing material, breeding material, inert material, etc.

In some embodiments, the NFP has a configuration for extended burnup and rim effect suppression. A primarily fissile first region may include 10% enriched LEU or similar and transition second region may include ²³⁸U or ²³²Th species (“Fertile”). An ‘inert’ material or component of a material may be ZrO₂ or other non-breeding material. Other additions may include moderators, such as BeO, or burnable neutron capturing materials, such as Gd₂O₃. It should be understood that any specific compositions described herein are exemplary and not limiting.

Generally, the NFP may include (e.g., be comprised of) any appropriate nuclear fuel material. In some embodiments, the nuclear fuel material may comprise one or more of uranium, zirconium, tungsten, rhenium, molybdenum, tantalum, iridium, uranium dioxide (UO₂), uranium oxide (e.g., U₃O₈), uranium nitride (e.g., UN, U₂N₃, etc.), uranium silicide (e.g., U₃Si₂), uranium borides (e.g., UB₂, UB₄), a transuranic material (e.g., plutonium, plutonium oxide), minor actinides (e.g. neptunium, americium, curium), thorium, oxides thereof, another nuclear fuel material, or combinations thereof. The NFP may also include (e.g., be comprised of) any appropriate additive, or dopant, material. In some embodiments, the additive material may be a neutron capturing material, such as a burnable neutron capturing material. In some embodiments, the neutron capturing material may comprise one or more of boron, gadolinium, gadolinium oxide (Gd₂O₃), boron carbide (B₄C), another material exhibiting a high thermal neutron absorption cross-section, and combinations thereof. Other neutron capturing materials may include, molybdenum, neodymium, cadmium, erbium, hafnium, another neutron absorber, or combinations thereof.

In some embodiments, the neutron capturing material may be disposed in a region of the NFP in which it will have the greatest impact on the nuclear reaction within a nuclear reactor (e.g., to enhance neutronic efficiency of the nuclear fuel material and the neutron capturing material therein) and may be excluded from other regions of the NFP. In some embodiments, the neutron capturing material may be excluded from a first region (e.g., a lateral and/or longitudinal center located proximate to the longitudinal axis) of the NFP so as to inhibit deformation (e.g., hour-glassing) of the NFP. In other embodiments, the neutron capturing material may also be excluded from or reduced in a gradient toward the axial surfaces of the NFP.

For example, the NFP be heterogeneous in composition across a height thereof (e.g., axially, in the longitudinal direction) and/or across a width thereof (e.g., radially from the longitudinal axis), such that amounts (e.g., concentrations) of one or more elements thereof are non-uniform within the NFP and/or within one or more regions of the NFP. The heterogeneity of the NFP and/or regions of the NFP may be substantially undetectable by visual inspection (e.g., no clear delineation of first region and second regions), but the heterogeneity of the NFP and/or regions of the NFP may be detectable by conventional spectroscopy or spectrometry techniques. A boundary between regions of different compositions within the fuel pellets may generally have a roughness at least partially defined by the microstructure of the NFP. Fine-grained and uniformed materials may exhibit a smoother or more uniform boundary, and coarse-grained materials may exhibit a rougher boundary. Some irregularity of the boundary may also be attributable to different particle sizes in various regions of the NFP.

A boundary layer is a region in which components of both neighboring regions mix and a boundary material is formed through the migration of materials. In some embodiments, a boundary layer between regions formed by overmolding and/or injection molding is smaller (e.g., thinner in a direction normal to the boundary surface 408 between regions) than powder sintering of two powder precursors adjacent to one another. The more precise control enabled by the overmolding and/or injection molding according to the present disclosure allows, in some embodiments, a boundary layer thickness of less than 500 micrometers, less than 300 micrometers, less than 200 micrometers, or less than 100 micrometers. The exact thickness of the boundary layer is at least partially dependent on the materials in each of the neighboring regions.

In some embodiments, the method of overmolding an NFP includes obtaining a first material containing a nuclear fuel in a first region with a longitudinal axis at and overmolding a second material in a second region around at least a radially outermost surface of the first material relative to the longitudinal axis. Obtaining a first material containing a nuclear fuel in a first region may include a variety of manufacturing techniques.

In some embodiments, the first region is formed through powder sintering of a precursor powder of the first material. The first material may be sintered or debinded to a densified or brown state in the first region before overmolding the second material in the second region. In other embodiments, the first region is formed by injection molding of a first material feedstock through a powder injection molding device into a first mold. The first material is compressed through the injection molding device into the first mold, where the first material assumes the shape of a void of the first mold in a green state. In yet other embodiments, the first material may be pressed without sintering or debinding to form the first region.

Overmolding the second material in the second region includes positioning the first material in a powder injection molding device in a mold with a void at least around a radially outermost surface of the first material. The second material is compressed through the injection molding device and urged into the void around the first material to assume the shape of the mold. In an embodiment where the first region is injection molded, the second material is injection molded using a second mold with a mold volume greater than the first mold used for the first region.

In some embodiments, the overmolding is performed with a powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets or the feedstock may contain a mixture of ceramic-matrix pellets and metal-matrix pellets that blend in the PIM device. Overmolding, as used herein, includes applying a second material to a surface of a first material when the first material is in a first region in a near-final state. Once the part is cooled and solidified, it may be removed from the mold. The entire injection forming process occurs on the order of seconds. Molds can be configured to produce dozens of LWR fuel pellet-sized parts at a time for efficient and rapid production of NFPs. In some embodiments, the overmolding process is repeated with another material that is applied to at least a radially outermost surface of a previous region.

In some embodiments, the feedstock for one or more of the materials injection molded into the NFP includes a binder. For example, the feedstock may include a binder that melts or softens during the PIM process to allow the feedstock pellets to flow through the PIM device more easily and for the material being injected into the mold to more easily assume the form of the void in the mold. In some embodiments, the binder is a wax binder, such as paraffin. In some embodiments, the binder is a polymer binder, such as polyethylene. In some embodiments, the feedstock includes both a wax binder and a polymer binder.

Because the first material, second material, or additional materials (such as the third material, fourth material, etc. described in some embodiments herein) may include binders, the NFP formed by overmolding may, optionally, require debinding. Debinding removes the wax and/or polymer binder matrix, leaving only the original raw material (such as UO₂) and may be performed through one or a combination of solvent, catalytic, or thermally driven processes. In some embodiments, the method further includes debinding the overmolded NFP by exposing the NFP to an elevated temperature greater than a temperature of the first material and/or second material during PIM. In some embodiments, debinding the overmolded NFP includes debinding at a second elevated temperature after debinding at the first elevated temperature. In at least one embodiment, debinding the overmolded NFP includes exposing the NFP to a solvent while heated to the first elevated temperature and/or second elevated temperature. For example, the NFP may be heated to a first elevated temperature while exposed to heptane, acetone, or another organic solvent. In another example, the NFP may be heated to a second elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering. In some embodiments, the ambient atmosphere around the NFP in the furnace can be changed to necessary atmosphere for sintering, which may include H₂ and vacuum capability to limit oxidation or other chemical changes during the sintering of the debinded NFP. In some embodiments, sintering the NFP also densifies the NFP, allowing the first material, second material, or other materials of the NFP to attain 98%, 99%, or approximately 100% of theoretical maximum density.

In some embodiments, a feedstock is loaded into a feed hopper of the PIM device. The feedstock may include a material pre-mixed with binders or may include a powder of the desired material with additional binders added to the powder. A screw or screws of the PIM device rotates to compound the feedstock through a barrel. In some embodiments, a heating element heats the barrel and/or screw(s) to soften and/or melt at least a portion of the feedstock. The feedstock flows past the plunger into the mold to form the molded part or a portion of the molded part.

As described herein, an NFP may have a cylindrical shape, but also may have other shapes depending on the need of the reactor. For example, an NFP according to the present disclosure may be formed by PIM around a mandrel. In some embodiments, the mandrel can support the NFP and regions thereof during the serial PIM of the first region, the second region, or more regions of different materials. In some embodiments, the mandrel can be subsequently removed by heating, melting, or dissolving the mandrel. In other examples, a support structure or scaffolding may be used with the PIM to provide a support structure during the PIM, which is later removed. In some embodiments, the void that remains in the NFP after removal of the mandrel and/or other support structure may aid in heat transfer or byproduct transfer through or out of the NFP.

In some embodiments, an NFP has a non-cylindrical shape. PIM allows for the NFP to have any shape produced by an injection molding process, such as slabs, parallelepipeds, spheres, polygons, etc. The individual layers or regions themselves may take on a variety of shapes or have irregular thicknesses (such as a corrugation, fluting, etc.). In one example, a first region is substantially spherical with a second region that has a substantially cylindrical outer surface. In another example, a first region is substantially cylindrical with a second region is a hexagonal prism allowing the outer surface of the NFP to facilitate hexagonal packing in a reactor.

Because PIM and other injection molding techniques discussed herein for overmolding provide a high grade of surface finish and surface quality, the NFP is removed from the mold in a near-final form. In some embodiments, an NFP in near-final form requires little or no final machining to provide an NFP in final form. In some examples, the NFP, upon removal form the mold, may require sintering and/or debinding but little or no final machining.

In some embodiments, a method of manufacturing an NFP includes injection molding of a first material feedstock containing a nuclear fuel through a powder injection molding device into a first mold. The first material is compressed through the injection molding device into the first mold, where the first material assumes the shape of a void of the first mold in a green state. In yet other embodiments, the first material may be pressed without sintering to form the first region.

Overmolding the second material in the second region includes positioning the first material in a powder injection molding device in a mold with a void at least around a radially outermost surface of the first material. The second material is compressed through the injection molding device and urged into the void around the first material to assume the shape of the mold. In an embodiment where the first region is injection molded, the second material is injection molded using a second mold with a mold volume greater than the first mold used for the first region.

In some embodiments, the overmolding is performed with a powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets, or the feedstock may contain a mixture of ceramic-matrix pellets and metal-matrix pellets that blend in the PIM device. Overmolding, as used herein, includes applying a second material to a surface of a first material when the first material is in a first region in a near-final state. Once the part is cooled and solidified, it may be removed from the mold. The entire injection forming process occurs on the order of seconds. Molds can be configured to produce dozens of LWR fuel pellet-sized parts at a time for efficient and rapid production of NFPs. In some embodiments, the overmolding process is repeated with another material that is applied to at least a radially outermost surface of a previous region.

In some embodiments, the feedstock for one or more of the materials injection molded into the NFP includes a binder. For example, the feedstock may include a binder that melts or softens during the PIM process to allow the feedstock pellets to flow through the PIM device more easily and for the material being injected into the mold to more easily assume the form of the void in the mold. In some embodiments, the binder is a wax binder, such as paraffin. In some embodiments, the binder is a polymer binder, such as polyethylene. In some embodiments, the feedstock includes both a wax binder and a polymer binder.

Because the first material, second material, or additional materials (such as the third material, fourth material, etc. described in some embodiments herein) may include binders, the NFP formed by overmolding may, optionally, require debinding. Debinding removes the wax and/or polymer binder matrix, leaving only the original raw material (such as UO₂) and may be performed through one or a combination of solvent, catalytic, or thermally driven processes. In some embodiments, the method further includes debinding the overmolded NFP by exposing the NFP to an elevated temperature greater than a temperature of the first material and/or second material during PIM. In some embodiments, debinding the overmolded NFP includes debinding at a second elevated temperature after debinding at the first elevated temperature. In at least one embodiment, debinding the overmolded NFP includes exposing the NFP to a solvent while heated to the first elevated temperature and/or second elevated temperature. For example, the NFP may be heated to a first elevated temperature while exposed to heptane, acetone, or another organic solvent. In another example, the NFP may be heated to a second elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering of at least one of the first material and the second material. In some embodiments, the ambient atmosphere around the NFP in the furnace can be changed to necessary atmosphere for sintering, which may include H₂ and vacuum capability to limit oxidation or other chemical changes during the sintering of the debinded NFP. In some embodiments, sintering the NFP also densifies at least one of the first material and the second material of the NFP, allowing the first material, second material, or other materials of the NFP to attain 98%, 99%, or approximately 100% of theoretical maximum density. In other embodiments, densifying at least one of the first material and the second material at is discrete from the sintering. For example, the sintering and the densifying at may occur at different temperatures or atmospheric conditions.

The present disclosure relates to NFPs and systems and methods for manufacturing thereof according to at least the examples provided in the sections below:

[A1] In some embodiments, a method of manufacturing a fuel pellet includes obtaining a first material containing a nuclear fuel in a first region with a longitudinal axis and overmolding a second material in a second region around at least a radially outermost surface of the first material relative to the longitudinal axis.

[A2] In some embodiments, the second region of [A1] includes at least part of an axial surface of the first material

[A3] In some embodiments, overmolding the second material of [A1] or [A2] includes powder injection molding the second material.

[A4] In some embodiments, the method of any of [A1] through [A3] includes debinding the first material and the second material at a first temperature.

[A5] In some embodiments, debinding of [A4] the first material and the second material at a first temperature includes exposing the first material and the second material to a solvent.

[A6] In some embodiments, the solvent of [A5] is heptane.

[A7] In some embodiments, the method of [A4] further includes, after debinding the first material and second material at the first temperature, debinding the first material and the second material at a second temperature.

[A8] In some embodiments, debinding the first material and the second material of [A7] at a second temperature includes exposing the first material and the second material to a negative ambient pressure.

[A9] In some embodiments, the method of any of [A1] through [A8] includes sintering the first material and the second material at a sintering temperature greater than a powder injection molding temperature.

[A10] In some embodiments, the first material of any of [A1] through [A9] includes the nuclear fuel and polymer binder.

[A11] In some embodiments, the first material of any of [A1] through [A10] includes the nuclear fuel and a wax binder.

[A12] In some embodiments, obtaining the first material of any of [A1] through [A11] includes powder injection molding the first material.

[A13] In some embodiments, the method of any of [A1] through [A12] overmolding a third material in a third region around at least a radially outermost surface of the second material relative to the longitudinal axis.

[B1] In some embodiments, a nuclear fuel pellet includes a first material containing a first nuclear fuel positioned in a first region proximate a longitudinal axis of the nuclear fuel pellet and a second material positioned in a second region around at least a radially outermost surface of the first material relative to the longitudinal axis, wherein a boundary layer between the first material and second material is less than 500 micrometers.

[B2] In some embodiments, the first nuclear fuel of [B1] includes uranium.

[B3] In some embodiments, the second material of [B1] or [B2] includes a nuclear breeding material.

[B4] In some embodiments, the nuclear breeding material of [B3] includes thorium.

[B5] In some embodiments, the second material of any of [B1] through [B4] includes a second nuclear fuel different from the first nuclear fuel.

[C1] In some embodiments, a method of manufacturing a fuel pellet includes injection molding a first material containing a nuclear fuel in a first region with a longitudinal axis and overmolding a second material via injection molding in a second region around at least a radially outermost surface of the first material relative to the longitudinal axis. The method further includes debinding at least one of the first material and the second material, sintering at least one of the first material and the second material, and densifying at least one of the first material and the second material.

[C2] In some embodiments, the first region of [C1] is located around a mandrel, and the method further comprises removing the mandrel.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of manufacturing a fuel pellet:
obtaining a first material containing a nuclear fuel in a first region with a longitudinal axis; and
overmolding a second material in a second region around at least a radially outermost surface of the first material relative to the longitudinal axis.

2. The method of claim 1, wherein the second region includes at least part of an axial surface of the first material.

3. The method of claim 1, wherein overmolding the second material includes powder injection molding the second material.

4. The method of claim 1, further comprising debinding the first material and the second material at a first temperature.

5. The method of claim 4, wherein debinding the first material and the second material at a first temperature includes exposing the first material and the second material to a solvent.

6. The method of claim 5, wherein the solvent is heptane.

7. The method of claim 4, further comprising, after debinding the first material and second material at the first temperature, debinding the first material and the second material at a second temperature.

8. The method of claim 7, wherein debinding the first material and the second material at a second temperature includes exposing the first material and the second material to a negative ambient pressure.

9. The method of claim 1, further comprising sintering the first material and the second material at a sintering temperature greater than a powder injection molding temperature.

10. The method of claim 1, wherein the first material includes the nuclear fuel and polymer binder.

11. The method of claim 1, wherein the first material includes the nuclear fuel and a wax binder.

12. The method of claim 1, wherein obtaining the first material includes powder injection molding the first material.

13. The method of claim 1, further comprising overmolding a third material in a third region around at least a radially outermost surface of the second material relative to the longitudinal axis.

14. A nuclear fuel pellet comprising:
a first material containing a first nuclear fuel positioned in a first region proximate a longitudinal axis of the nuclear fuel pellet; and
a second material positioned in a second region around at least a radially outermost surface of the first material relative to the longitudinal axis, wherein a boundary layer between the first material and second material is less than 500 micrometers.

15. The nuclear fuel pellet of claim 14, wherein the first nuclear fuel includes uranium.

16. The nuclear fuel pellet of claim 14, wherein the second material includes a nuclear breeding material.

17. The nuclear fuel pellet of claim 16, wherein the nuclear breeding material includes thorium.

18. The nuclear fuel pellet of claim 14, wherein the second material includes a second nuclear fuel different from the first nuclear fuel.

19. A method of manufacturing a fuel pellet:
injection molding a first material containing a nuclear fuel in a first region with a longitudinal axis;
overmolding a second material via injection molding in a second region around at least a radially outermost surface of the first material relative to the longitudinal axis;
debinding at least one of the first material and the second material;
sintering at least one of the first material and the second material; and
densifying at least one of the first material and the second material.

20. The method of claim 19, wherein the first region is located around a mandrel, and the method further comprises removing the mandrel.
